(19) United States
(12) Patent Application Publication
(10) Pub. No.: US 2004/0019736 A1
(43) Pub. Date: Jan. 29, 2004

(54) Portable flash memory with extended memory capacity

(76) Inventors: Dug-Soo Kim, Seoul (KR); Dong-Jin Kim, Incheon (KR); Seong-Soo Park, Seoul (KR)

Correspondence Address: BLAKE, CASSELS & GRAYDON, LLP, 45 O'CONNOR ST., 20TH FLOOR, OTTAWA, ON, K1P 1A4, CA

(21) Appl. No.: 10/378,638

(22) Filed: Mar. 5, 2003

(30) Foreign Application Priority Data
Jul. 23, 2002 (KR) 2002-43404

(51) Int. Cl. G06F 12/00

(52) U.S. Cl. 711/103; 711/154

(57) ABSTRACT

Disclosed is a portable flash memory with extended memory capacity comprising a main body connected to a host computer and an extended body connected to the main body. The main body comprises a flash memory being a nonvolatile memory for electrically recording or erasing data, an USB interface connected to a USB port of the host computer so as to output data recorded on the flash. memory to the host computer or connect the host computer to the main body to receive data outputted from the host computer and record the data on the flash memory, an extended interface connected to the extended body so as to connect the extended body to the main body, and a microcomputer for controlling data input/output between the flash memory and the host computer and controlling the operation of the extended body. The extended body comprises an extended flash memory being a nonvolatile memory for electrically recording or erasing data, and an extended interface correspondingly connected to the extended interface of the main body. The portable flash memory is handy to carry and easy to extend in its memory capacity.

### BACKGROUND OF THE INVENTION

1. Field of the Invention

The present invention relates to a portable flash memory with extended memory capacity.

2. Description of the Related Art

Generally, flash memories are next-generation storage units for replacing HDDs (hard disk drives). Further, as well known to those skilled in the art, the flash memories are non-volatile memories. Since the flash memories are IC (integrated circuit) memories, compared to the mechanically operated HDDs, the flash memories are reduced in size and weight, and have excellent impact resistance and low failure rate. Data are electrically recorded on or erased from the flash memories. In erasing data from the flash memory, data are simultaneously erased from the flash memory per chip or per block. On the other hand, in recoding data on the flash memory, the data are recorded on the flash memory per byte. EEPROM (electrically erasable and programmable read only memory) , from which data are erased byte-by-byte, uses several transistors to record one bit of data thereon. However, since the flash memory uses just one transistor to record one bit of data thereon, compared to the EEPROM, the flash memory has a smaller size and is lower-priced.

A USB (Universal Serial Bus) is a new serial interface system being recently used in PCs. The USB system is a standard being developed in order to effectively connect peripheral devices to the PC. The USB standard provides a smaller format factor and excellent user interface environment. The USB standard can support an easy expansion of peripheral devices of PC, a maximum transmission rate of more than 480 Mbps per sec, perfect video/audio data, and an ability for introducing a protocol for mixed mode isochronous data transmitting and asynchronous messaging, and a technical integration of devices. Under the USB standard, the peripheral devices can be self-identified, support an automatic mapping function, and be dynamically attached to the PCs and reconstructed with the PCs.

The present inventors are aware that a portable apparatus, which is handy to carry and, if necessary, simply connected to a host computer such as a PC or a notebook computer so as to input/output data, is necessary. Therefore, by simultaneously employing the aforementioned flash memory technique and USB standard technique, the present inventors have researched and developed a portable flash memory being simply connected to a USB port of a host computer so as to record and erase data, thereby being easy to extend in its memory capacity and improving a user's convenience.

### SUMMARY OF THE INVENTION

Therefore, the present invention has been made in view of the above problems, and it is an object of the present invention to provide a portable flash memory which is simply connected to a USB port of a host computer so as to record and erase data, thereby being easy to extend in its memory capacity.

It is another object of the present invention to provide a portable flash memory with extended memory capacity in which an extended flash memory and a main flash memory are recognized as a single drive or as individual drives.

In accordance with one aspect of the present invention, the above and other objects can be accomplished by the provision of a portable flash memory with extended memory capacity comprising a main body connected to a host computer and an extended body connected to the main body, wherein the main body comprises a flash memory being a nonvolatile memory for electrically recording or erasing data; an USB interface connected to a USB port of the host computer so as to output data recorded on the flash memory to the host computer or connect the host computer to the main body to receive data outputted from the host computer and record the data on the flash memory; an extended interface connected to the extended body so as to connect the extended body to the main body; and a microcomputer for controlling data input/output between the flash memory and the host computer and controlling the operation of the extended body.

Preferably, the extended body may comprise an extended flash memory being a nonvolatile memory for electrically recording or erasing data; and an extended interface correspondingly connected to the extended interface of the main body.

Further, preferably, the main body may further comprise a mode selection switch for selecting one of a single mode or a separate mode, wherein when the single mode is selected, the extended flash memory of the extended body is recognized as the same drive as that of the flash memory of the main body, and when the separate mode is selected, the extended flash memory of the extended body is recognized as another drive different from that of the flash memory of the main body.

In accordance with another aspect of the present invention, there is provided a portable flash memory with extended memory capacity comprising a flash memory being a nonvolatile memory for electrically recording or erasing data; an USB interface connected to a USB port of the host computer so as to output data recorded on the flash memory to the host computer or connect the host computer to the portable flash memory in order to receive data outputted from the host computer and record the data on the flash memory; a memory card interface connected to a flash memory card; and a microcomputer for controlling data input/output between the flash memory and the host computer and controlling the operation of the flash memory card.

Preferably, the portable flash memory with extended memory capacity may further comprise a mode selection switch for selecting one from a single mode and a separate mode, wherein when the single mode is selected, the flash memory card is recognized as the same drive as that of the flash memory, and when the separate mode is selected, the flash memory card is recognized as another drive different from that of the flash memory.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram of a portable flash memory with extended memory capacity in accordance with a first embodiment of the present invention;

FIG. 2 is a block diagram of a portable flash memory with extended memory capacity in accordance with a second embodiment of the present invention; and

FIGS. 3a and 3b are schematically exploded plan and side views of the portable flash memory with extended memory capacity in accordance with the present invention, respectively.

### DESCRIPTION OF THE PREFERRED EMBODIMENTS

Now, preferred embodiments of the present invention will be described in detail with reference to the annexed drawings.

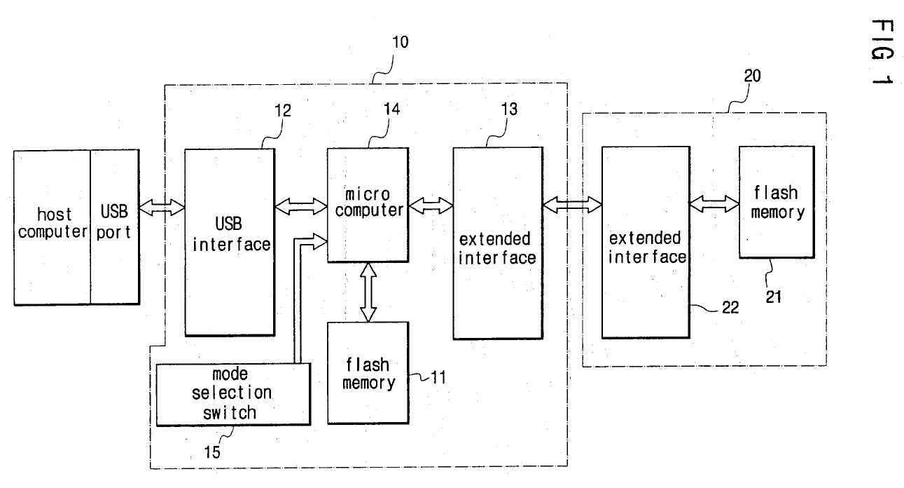

FIG. 1 is a block diagram of a portable flash memory with extended memory capacity in accordance with a first embodiment of the present invention.

As shown in FIG. 1, in accordance with this embodiment of the present invention, the portable flash memory with extended memory capacity comprises a main body 10 connected to a host computer, and an extended body 20 connected to the main body 10.

The main body 10 comprises a flash memory 11, a USB (Universal Serial Bus) interface 12, an extended interface 13, and a microcomputer 14.

The flash memory 11 is a nonvolatile memory for electrically recording or erasing data.

Since the flash memory technique has already been described above, its detailed description will be omitted.

The USB interface 12 is connected to a USB port of the host computer, thereby outputting data recorded on the flash memory 11 to the host computer, or connecting the host computer to the main body 10 so as to receive data outputted from the host computer and record the data on the flash memory 11.

Since the USB standard technique has also been described above, its detailed description will be omitted.

The extended interface 13 is connected to the extended body 20, thereby electrically connecting the extended body 20 to the main body 10.

The microcomputer 14 controls data input/output between the flash memory 11 and the host computer, and controls the operation of the extended body 20. That is, the microcomputer 14 controls the whole operation of the portable flash memory.

The extended body 20 comprises an extended flash memory 21 and an extended interface 22.

The extended flash memory 21 is a nonvolatile memory for electrically recording or erasing data.

The extended interface 22 is correspondingly connected to the extended interface 13 of the main body 10.

For example, the extended interface 13 of the main body 10 is formed as a female connector, and the extended interface 22 of the extended body 20 is formed as a male connector so as to be coupled with the female connector.

Optionally, the main body 10 further comprises a mode selection switch 15. Using the mode selection switch 15, one mode. is selected from a single mode and a separate mode. When the single mode is selected, the extended flash memory 21 of the extended body 20 is combined with the flash memory 11 of the main body 10, and the combined memories of the extended flash memory 21 and flash memory 11 are recognized as a single drive. Alternatively, when the separate mode is selected, the extended flash memory 21 of the extended body 20 is separated from the flash memory 11 of the main body 10, the extended flash memory 21 and the flash memory 11 are respectively recognized as individual drives.

For example, In case the flash memory 11 of the main body 10 is set as a D drive by the host computer, when the single mode is selected, the extended flash memory 21 of the extended body 20 is set as the same D drive, thereby extending the capacity of the D drive. On the other hand, at this time, when the separate mode is selected, the extended flash memory 21 of the extended body 20 is set as another drive different from the D drive of the flash memory 11 of the main body 10, such as an E drive.

Therefore, in the portable flash memory with extended memory capacity in accordance with this embodiment of the present invention, when a user connects the USB interface 12 of the main body 10 to the USB port of the host computer, the flash memory 11 of the main body 10 is set as an auxiliary memory unit of the host computer by an operation of an installation software or a firmware, installed and operated in the host computer.

After the extended interface 22 of the extended body 20 is connected to the extended interface 13 of the main body 10, one is selected from the two modes using the mode selection switch 15. By the operation of the installation software or firmware, installed and operated in the host computer, in case the single mode is selected, the extended flash memory 21 of the extended body 20 is recognized as the same drive as that of the flash memory 11 of the main body 10, and in case the separate mode is selected, the extended flash memory 21 of the extended body 20 is recognized as another drive different from that of the flash memory 11 of the main body 10. Thereby, the capacity of the portable flash memory is extended.

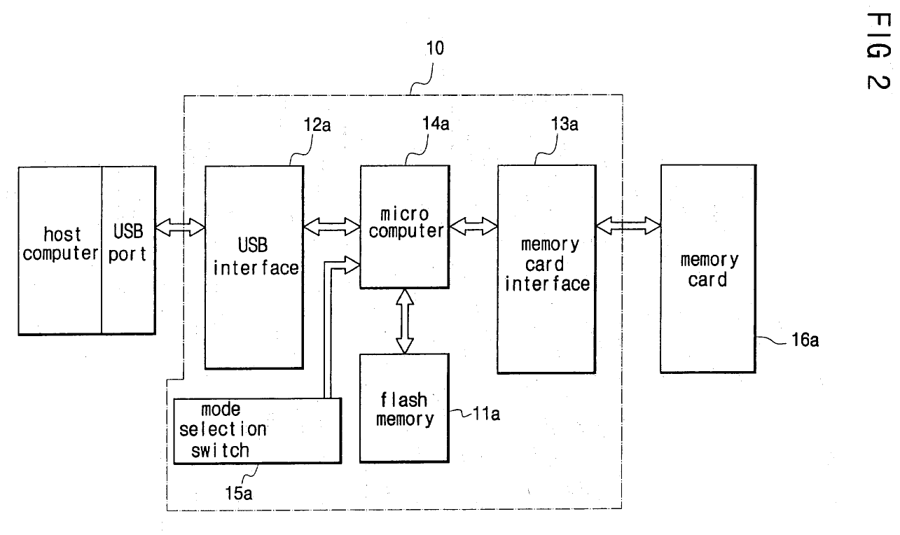

FIG. 2 is a block diagram of a portable flash memory with extended memory capacity in accordance with a second embodiment of the present invention.

As shown in FIG. 2, in accordance with this embodiment of the present invention, the portable flash memory with extended memory capacity comprises a flash memory 11a, a USB interface 12a, a memory card interface 13a, and a microcomputer 14a.

The flash memory 11a is a nonvolatile memory for electrically recording or erasing data.

The USB interface 12a is connected to a USB port of the host computer, thereby outputting data recorded on the flash memory 11a to the host computer, or connecting the host computer to the main body 10 so as to receive data outputted from the host computer and record the data on the flash memory 11a.

A flash memory card 16a is connected to the memory card interface 13a of the main body 10.

The microcomputer 14a controls data input/output between the flash memory 11a and the host computer, and controls an operation of the flash memory card 16a.

The flash memory card 16a is a micro-sized memory card using a flash memory used in a digital camera, a PDA (Personal Digital Assistant), and a portable MP3 player. The flash memory card 16a is connected to the main body of the host computer, thereby recording and storing data by the operation of the software installed on the main body.

Optionally, the main body 10 further comprises a mode selection switch 15a. Using the mode selection switch 15a, one mode is selected from a single mode and a separate mode. when the single mode is selected, the flash memory card 16a is combined with the flash memory 11a, and the combined memories of the flash memory card 16a and flash memory 11a are recognized as a single drive. Alternatively, when the separate mode is selected, the flash memory card 16a is separated from the flash memory 11a, the flash memory card 16a and the flash memory 11a are respectively recognized as individual drives.

For example, in case the flash memory 11a of the main body 10 is set as a D drive by the host computer, when the single mode is selected, the flash memory card 16a is set as the same D drive, thereby extending the capacity of the D drive. On the other hand, at this time, when the separate mode is selected, the flash memory card 16a is set as another drive different from the D drive of the flash memory 11a, such as an E drive.

Therefore, in the portable flash memory with extended memory capacity in accordance with this embodiment of the present invention, when a user connects the USB interface 12a of the main body 10 to the USB port of the host computer, the flash memory 11a of the main body 10 is set as an auxiliary memory unit of the host computer by an operation of an installation software or a firmware, installed and operated in the host computer.

After the flash memory card 16a is connected to the memory card interface 13a, one mode is selected from the two modes using the mode selection switch 15a. By the operation of the installation software or firmware, installed and operated in the host computer, in case the single mode is selected, the flash memory card 16a is recognized as the same drive as that of the flash memory 11a, and in case the separate mode is selected, the flash memory card 16a is recognized as another drive different from that of the flash memory 11a. Thereby, the capacity of the portable flash memory is extended.

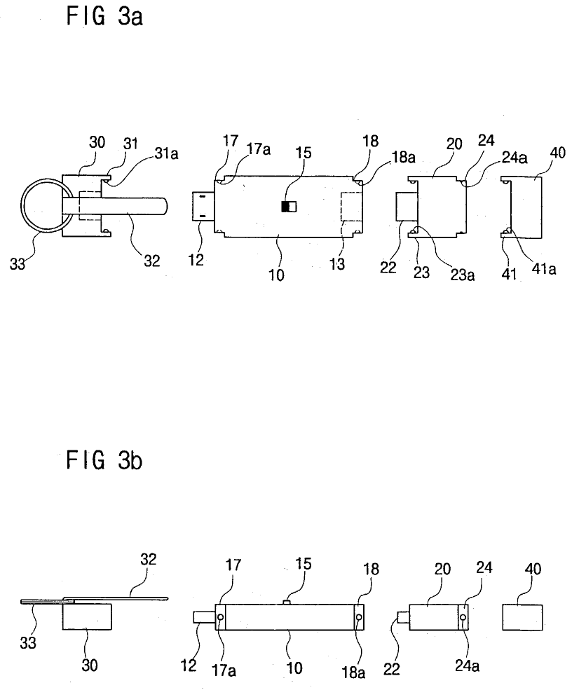

FIGS. 3a and 3b schematically show the portable flash memory with extended memory capacity in accordance with the present invention.

As shown in FIGS. 3a and 3b, the portable flash memory with extended memory capacity comprises the main body 10, the extended body 20, a first lid 30, and a second lid 40.

The main body 10 comprises the USB interface 12, first guiding sections 17, first grooves 17a, the extended interface 13, second guiding sections 18, and second grooves 18a. The USB interface 12 is protruded from one side surface of the main body 10 so as to be connected to the USB port of the host computer. The first guiding sections 17 are formed by partially cutting both ends of the side surface of the main body where the USB interface 12 is formed, and the first grooves 17a are formed on a designated position of each guiding surface of the first guiding sections 17. The extended interface 13 is formed on the side surface of the main body 10 being opposite to the USB interface 12 so as to be connected to the extended body 20. The second guiding sections 18 are formed by partially cutting both ends of the side surface of the main body where the extended interface 13 is formed, and the second grooves 18a are formed on a designated position of each guiding surface of the second guiding sections 18.

The extended body 20 comprises the extended interface 22, guiding segments 23, protrusions 23a, guiding sections 24, and grooves 24a. The extended interface 22 is correspondingly connected to the extended interface 13 of the main body 10. The guiding segments 23 are protruded from both ends of the side surface where the extended interface 22 is formed, so as to be guided by the second guiding sections 18 of the main body 10. The protrusions 23a protrude from a designated position of each guiding segment 23, thereby being coupled with the corresponding second grooves 18a of the second guiding sections 18. The guiding sections 24 are formed by partially cutting both ends of the side surface of the extended body 20 being opposite to the guiding segments 23, and the grooves 24a are formed on a designated position of each guiding surface of the guiding sections 24.

The first lid 30 comprises first guiding segments 31 and first protrusions 31a. The first guiding segments 31 are protruded from both ends of one side surface of the first lid 30 so as to be guided by the first guiding sections 17 of the main body 10. The first protrusions 31a protrude from a designated position of each first guiding segment 31, thereby being coupled with the corresponding first grooves 17a of the first guiding sections 17.

The first lid 30 further comprises a clip 32 and a ring 33. The clip 32 is formed on any one surface selected from the surfaces of the first lid 30 except for the side surface where the first guiding segments 31 are formed. The ring 30 is integrally formed with the clip 32.

Therefore, the portable flash memory of the present invention can be inserted into a user's pocket using the clip 32, and carry keys using the ring 30.

The second lid 40 comprises second guiding segments 41 and second protrusions 41a. The second guiding segments 41 are protruded from both ends of one side surface of the second lid 40 so as to be guided by the second guiding sections 18 of the main body 10 or the guiding sections 24 of the extended body 20. The second protrusions 41a protrude from a designated position of each second guiding segment 41, thereby being coupled with the corresponding second grooves 18a of the second guiding sections 18 or the corresponding grooves 24a of the guiding sections 24.

Therefore, when a user carries the portable flash memory of the present invention, one end of the main body 10 is connected to the first lid 30 and the other end of the main body 10 is connected to the second lid 40 or the extended body 20. In case one end of the extended body 20 is connected to the main body 10, the other end of the extended body 20 is connected to the second lid 20.

As apparent from the above description, the present invention provides a portable flash memory, which is simply connected to the USB port of the host computer so as to record and erase data and in which an extended flash memory and a main flash memory are recognized as a single drive or as individual drives, thereby being handy to carry and easy to extend in its memory capacity, and being convenient to users.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A portable flash memory with extended memory capacity comprising a main body connected to a host computer and an extended body connected to the main body, wherein the main body comprises:
a flash memory being a nonvolatile memory for electrically recording or erasing data;
an USB interface connected to a USB port of the host computer so as to output data recorded on the flash memory to the host computer or connect the host computer to the main body to receive data outputted from the host computer and record the data on the flash memory;
an extended interface connected to the extended body so as to connect the extended body to the main body; and
a microcomputer for controlling data input/output between the flash memory and the host computer and controlling the operation of the extended body.

2. The portable flash memory with extended memory capacity as set forth in claim 1, wherein the extended body comprises:
an extended flash memory being a nonvolatile memory for electrically recording or erasing data; and
an extended interface correspondingly connected to the extended interface of the main body.

3. The portable flash memory with extended memory capacity as set forth in claim 1, wherein the main body further comprises a mode selection switch for selecting one from a single mode and a separate mode, in case the single mode is selected, the extended flash memory of the extended body is recognized as the same drive as that of the flash memory of the main body, and in case the separate mode is selected, the extended flash memory of the extended body is recognized as another drive different from that of the flash memory of the main body.

4. The portable flash memory with extended memory capacity as set forth in claim 2, wherein the main body further comprises a mode selection switch for selecting one from a single mode and a separate mode, in case the single mode is selected, the extended flash memory of the extended body is recognized as the same drive as that of the flash memory of the main body, and in case the separate mode is selected, the extended flash memory of the extended body is recognized as another drive different from that of the flash memory of the main body.

5. A portable flash memory with extended memory capacity comprising:
a flash memory being a nonvolatile memory for electrically recording or erasing data;
an USB interface connected to a USB port of the host computer so as to output data recorded on the flash memory to the host computer or connect the host computer to the portable flash memory in order to receive data outputted from the host computer and record the data on the flash memory;
a memory card interface connected to a flash memory card; and
a microcomputer for controlling data input/output between the flash memory and the host computer and controlling the operation of the flash memory card.

6. The portable flash memory with extended memory capacity as set forth in claim 5, further comprising a mode selection switch for selecting one from a single mode and a separate mode, in case the single mode is selected, the flash memory card is recognized as the same drive as that of the flash memory, and in case the separate mode is selected, the flash memory card is recognized as another drive different from that of the flash memory.

7. A portable flash memory with extended memory capacity comprising:
a main body including:
a USB interface protruded from one side surface of the main body so as to be connected to a USB port of a host computer;
first guiding sections formed by partially cutting both ends of the side surface of the main body where the USB interface is formed;
first grooves formed on a designated position of each guiding surface of the first guiding sections;
an extended interface formed on the side surface of the main body being opposite to the USB interface so as to be connected to an extended body;
second guiding sections formed by partially cutting both ends of the side surface of the main body where the extended interface is formed; and
second grooves formed on a designated position of each guiding surface of the second guiding sections;
an extended body including:
an extended interface correspondingly connected to the extended interface of the main body;
guiding segments protruded from both ends of the side surface where the extended interface is formed, so as to be guided by the second guiding sections of the main body;
protrusions protruding from a designated position of each guiding segment so as to be coupled with the corresponding second grooves of the second guiding sections;
guiding sections formed by partially cutting both ends of the side surface of the extended body being opposite to the guiding segments; and
grooves formed on a designated position of each guiding surface of the guiding sections;
a first lid including:
first guiding segments protruded from both ends of one side surface of the first lid so as to be guided by the first guiding sections of the main body; and
first protrusions protruding from a designated position of each first guiding segment, so as to be coupled with the corresponding first grooves of the first guiding sections; and
a second lid including:
second guiding segments protruded from both ends of one side surface of the second lid so as to be guided by the second guiding sections of the main body or the guiding sections of the extended body; and
second protrusions protruding from a designated position of each second guiding segment, so as to be coupled with the corresponding second grooves of the second guiding sections or the corresponding grooves of the guiding sections.

8. The portable flash memory with extended memory capacity as set forth in claim 7, wherein the first lid further comprises a clip formed on any one surface selected from the surfaces of the first lid except for the side surface where the first guiding segments are formed.

9. The portable flash memory with extended memory capacity as set forth in claim 8, wherein the first lid further comprises a ring integrally formed with the clip.
